(19) United States
(12) Patent Application Publication
(10) Pub. No.: US 2022/0287280 A1
(43) Pub. Date: Sep. 15, 2022

(54) RADIAL FAN FOR AN INCUBATOR

(71) Applicant: PAS REFORM B.V, ZEDDAM (NL)

(72) Inventor: Marco VAN DER LEIJ, ZEDDAM (NL)

(73) Assignee: PAS REFORM B.V, ZEDDAM (NL)

(21) Appl. No.: 17/636,149

(22) PCT Filed: Sep. 7, 2020
(86) PCT No.: PCT/NL2020/050551

§ 371 Date: Feb. 17, 2022

(30) Foreign Application Priority Data
Sep. 5, 2019 (NL) 2023778

(51) Int. Cl. A01K 41/02; F04D 17/00; F04D 29/28; A01K 41/04

(52) U.S. Cl. CPC A01K 41/023; F04D 17/00; F04D 29/281; A01K 41/04

(57) ABSTRACT

A radial fan for an incubator for poultry eggs and newly hatched poultry. The fan has a longitudinally-elongated, hub and a plurality of self-supporting, radially-extending, fan blades on the hub. Each blade is laterally deformable, so that it is deformed by air pressure in a counter-clockwise direction when the hub is rotated in a clockwise direction and is deformed by air pressure in a clockwise direction when the hub is rotated in a counter-clockwise direction.

### TECHNICAL FIELD

The present invention relates to a radial fan for circulating air throughout the interior of an incubator or incubation chamber for poultry eggs and newly hatched poultry, particularly for chicken eggs and newly hatched chicks. More particularly, the invention relates to a radial fan which can provide, around the eggs and/or the newly hatched poultry, a flow of air with a reduced clockwise and/or counter-clockwise spin in a setter and/or a hatcher of an incubator. Still more particularly, the invention relates to a radial fan which can be rotated in opposite directions to move air, within the incubator, with a reduced clockwise spin and a reduced counter-clockwise spin.

### BACKGROUND OF THE INVENTION

The use of fans is well known for circulating air, which can be heated or cooled, throughout the stacks of filled egg trays in a commercial incubator for poultry, particularly chicken, see, for example, DE 946671 C, TW 201 402 005 A, U.S. Pat. Nos. 2,791,199, 4,957,066 and 5,025,619.

However, it has become recognized that conventional fans produce flows of air with a significant clockwise or counter-clockwise spin around the numerous eggs and newly hatched poultry in an incubator. Because of this significant spin, air needs to travel a longer distance to and from the fans and around the eggs and newly hatched poultry in the incubator. Such a condition is not optimal for the development of poultry hatching from the eggs. In particular, air flows with a significant spin tend to cause significant variations in the temperatures of embryos in the eggs in the incubator.

Ways have been sought, therefore, for providing flows of air with less clockwise or counter-clockwise spin around the eggs and newly hatched poultry in the incubator.

Radial fixed blade fans, such as e.g. disclosed in U.S. Pat. No. 3,385,516, generate only highly directed air flows.

Accordingly, in particular, ways have been sought for providing air flows with less spin around the eggs which, it is believed, would help to make embryo temperatures more uniform throughout the egg mass in the incubator, thereby reducing mortality in the incubator. In this respect, the fan and heater combination disclosed in DE 946671 C is directed at creating airflow in an incubator chamber when rotated alternatingly clockwise and counter clockwise. The radial fan disclosed in this document comprises rigid linear blades, which are pairwise pitched in opposite directions. While this may create pulsed different air flows depending on the rotation direction, trailing fan blades immediately negate the air flow created by a previous blade, thereby reducing the efficacy of such fans for airing larger incubator spaces while creating spin, as visible from the drawings whereby the incubator trays are spaced in immediate proximity to the fan blades.

Accordingly, there remains a need for the provision of flows of air with less spin around the eggs, however with a deeper penetration into the incubator as compared to the the fan and heater combination disclosed in DE 946671 C.

### SUMMARY OF THE INVENTION

In a first aspect, the present invention provides a radial fan for providing a uniform airflow in an incubator, comprising a longitudinally-elongated, generally tubular hub and a plurality of self-supporting, longitudinally- and radially-extending, planar fan blades, arranged circumferentially around a longitudinally-extending axis of the hub; the hub being rotatable clockwise and counter-clockwise around the axis of the hub to rotate the blades clockwise and counter-clockwise around the axis of the hub; wherein each blade is configured to deform under rotation and/or air pressure such that the distal end of each blade is biased aft of the blade radial axis in the rotation direction. the second and further portions of each blade being deformable, preferably bendable, laterally whereby the second and further portions is: i) deformed, preferably bent and curved, laterally in a counter-clockwise direction by air pressure when being rotated in a clockwise direction by the hub, and ii) deformed, preferably bent and curved, laterally in a clockwise direction by air pressure when being rotated in a counter-clockwise direction by the hub. By this deformation, a uniform air flow is created with a slow spin level.

Preferably, the first portion of each blade is significantly more rigid laterally than the second portion of the blade. More preferably, the first portion of each blade is substantially rigid laterally, and the second portion of each blade is flexible laterally. Even more preferably, the first portion of each blade is made from a light weight metal, particularly aluminium, and the second portion of each blade is made from a non-rigid plastic material, particularly polypropylene. Yet more preferably, the first portion of each blade is not substantially deformed even when being rotated by the hub. Preferably, the first portion of each blade may be made from a light weight material, preferably sufficiently strong to maintain the blades attached to the hub during operation, preferably, the material comprising a metal or metal alloy, such as particularly aluminium or alloys thereof, whereas the second and further portions of each blade are made from a non-rigid polymeric material composition, particularly plastic material more preferably polypropylene. Alternatively, the first and second portions of each blade are made as a single, self-supporting piece from a plastic, with the second portion being significantly more deformable laterally than the first portion.

Also preferably, the fan comprises at least four, more preferably five to eight, still more preferably five or six, blades.

In a second aspect, the present invention relates to an incubator for poultry eggs and newly hatched poultry comprising a radial fan with a longitudinally-elongated, generally tubular hub and a plurality of longitudinally- and radially-extending, self-supporting, fan blades, arranged circumferentially around a longitudinally-extending axis of the hub; the axis of the hub extending into the interior of the incubator; the hub being rotatable clockwise and counter-clockwise around the axis of the hub to rotate the blades clockwise and counter-clockwise around the axis of the hub; and a portion of each blade being deformable, preferably bendable, laterally whereby the portion is: i) deformed, preferably bent and curved, laterally in a counter-clockwise direction by air pressure when being rotated in a clockwise direction by the hub, and ii) deformed, preferably bent and curved, laterally in a clockwise direction by air pressure when being rotated in a counter-clockwise direction by the hub. Preferably, the radial fan in the incubator is the radial fan of the first aspect of the invention.

### BRIEF DESCRIPTION OF THE DRAWINGS

FIG. 1 is a perspective view of a first embodiment of a radial fan of this invention from a first longitudinal end portion of its hub; the hub of the fan is mounted on a reversible torque source or motor, rearwardly of the fan.

FIG. 2 is a perspective, partially exploded view of a second embodiment of the radial fan of this invention from a first longitudinal end portion of its hub.

### DETAILED DESCRIPTION OF THE INVENTION

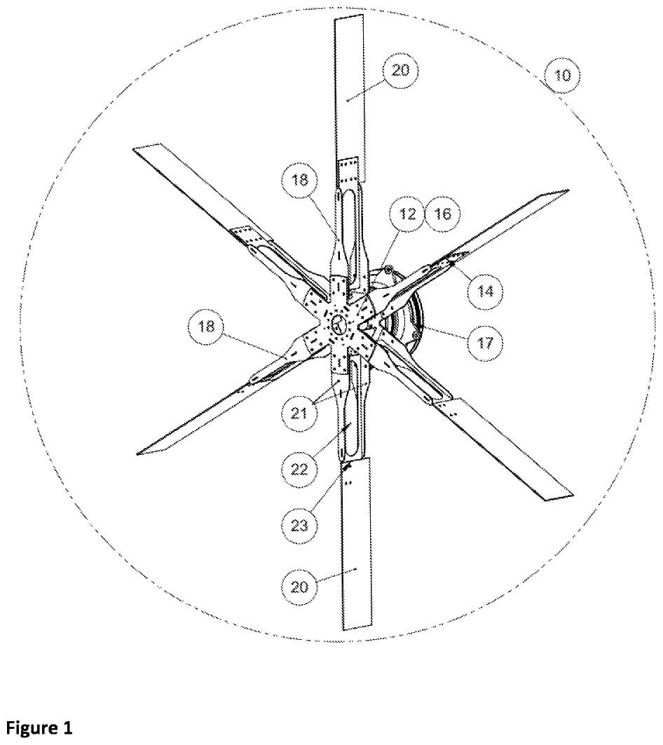

In accordance with this invention, a first embodiment of a radial fan 10 is provided as shown in FIG. 1. The fan 10 of FIG. 1 is particularly well suited to provide air flows with less clockwise or counter-clockwise spin (i.e., less left or right spin) around poultry eggs and newly hatched poultry in an incubator (not shown), particularly in either a setter or a hatcher. The fan has, at its radial centre, a longitudinally-elongated, generally tubular hub 12. A plurality of, radially-extending, preferably self-supporting, fan blades 14, are arranged circumferentially around a first longitudinal end portion 16 of the hub 12. Each blade extends radially away from the hub 12. In accordance with this invention, the hub 12 can be rotated clockwise and counter-clockwise around its longitudinal axis to rotate the blades 14 clockwise and counter-clockwise around the longitudinal axis of the hub. For this purpose, a source 17 of a reversible torque can be attached to an opposite, second longitudinal end portion of the hub 12 to propel the hub to rotate in opposite directions about its longitudinal axis. The reversible torque source 17 can be a conventional reversible electric motor, an iso electro motor, an air motor or a V-belt.

A first portion 18 of each blade 14 of the fan 10 of FIG. 1 is adjacent and attached to the circumference of the hub 12. A second portion 20 of each blade 14 is attached to the first portion 18 of the blade and extends radially away from the first portion 18. The second portion 20 of each blade is deformable, preferably bendable, laterally. As a result, the second portion 20 is deformed, preferably bent and curved, laterally in a counter-clockwise direction by air pressure when being rotated by the hub 12 in a clockwise direction about the longitudinal axis of the hub and is deformed, preferably bent and curved, laterally in a clockwise direction by air pressure when being rotated by the hub in a counter-clockwise direction about the longitudinal axis of the hub. Preferably, the first portion 18 of each blade 14 is significantly more rigid laterally than the second portion 20 of the blade. More preferably, the first portion of each blade is substantially rigid laterally, and the second portions of each blade is flexible laterally. In this regard, the fan 10 is preferably a straight backward curved multi-bladed radial flow device rotatable about its axis, whereby the blades preferably deform under rotation to form backward curved blades relative to the rotation direction and provide a more planar air flow with less swirl.

Herein, the term “longitudinal” preferably means in a direction extending along the axis of the tubular hub 12 of the fan 10 of this invention. Also herein, the term “radial” preferably means in a direction extending towards and away from the axis of the tubular hubs of the fans of this invention.

Also herein, the term “lateral” preferably means in a direction extending clockwise or counter-clockwise about the axis of the hub 12.

Also herein, the term “poultry” preferably means chicks, ducklings, geese or turkeys, particularly chicks.

Also herein, the terms “incubator” and “incubation chamber” preferably mean a setter or a hatcher for poultry.

Also herein, the term “deformed laterally”, with regard to each blade 14 of the radial fan 10 of this invention, preferably means that rotation of the hub 12 of the fan 10 causes the blade to be significantly bent or deformed laterally but not significantly deformed longitudinally, and not completely or totally bent or deformed laterally whereby the radial end of the blade contacts an adjacent blade.

Also herein, the terms “clockwise” and “counter-clockwise” preferably refer to directions of circular movement around the axis of the hub 12 of the fan 10.

Also herein, the term “self-supporting”, with regard to each blade 14 of the radial fan 10 of this invention, preferably means having a defined shape, and thus not being formless or limp, when not being rotated by the hub 12 of the fan and more preferably means being substantially planar laterally and longitudinally when not being rotated by the hub of the fan.

Also herein, the term “planar”, with regard to each blade 14 of the radial fan 10 of this invention, preferably means that the blade and its first and second parts 18 and 20, when not being rotated by the hub 12, are as shown in FIG. 1, i.e., not significantly bent or deformed laterally or longitudinally.

Also herein, the term “significantly more rigid” preferably refers to the first portion 18 of each blade 14 of the radial fan of this invention being at least 5%, more preferably at least 10%, again more preferably at least 15%, yet more preferably at least 20% more rigid laterally than the second portion 20 of the blade under the air pressure from rotation of the fan about its hub 12. In this regard, the lateral rigidity of a blade can gradually change over the radial length of the blade, e.g., by giving the blade a radially tapered I thickness.

Preferably, the second portion 20 of each blade 14 is made of a deformable polymeric plastic material, such as low-density polyethylene, plasticised polyvinyl chloride or polypropylene or engineering plastic. The first portion 18 of each blade 14 is preferably made of a metal such as aluminium or a relatively rigid plastic such as a non-plasticised polyvinyl chloride, polypropylene or a high-density polyethylene. Alternatively, each blade 14 and its first and second portions 18, 20 can be made as a single, self-supporting piece from a plastic, preferably from a somewhat rigid but also somewhat flexible polypropylene, with a second portion 20 that is significantly more deformable laterally than its first portion 18.

Preferably, the second portion 20 of each blade 14 is deformable under the air pressure generated by rotation of the fan 10, such that each blade assumes a backward-curved crest when the fan is operating, with respect to the rotation direction around the hub 12. In this regard, the term “backward curved” herein refers to the blade 14, when viewed along the axis of rotation of the fan 1014, having a root from which the blade extends both outwardly and backwardly relative to a radius from the axis of rotation, whereby relative to the direction of rotation, the root is the leading part of the blade and the top end the trailing part.

Preferably, the thickness of each blade over the length of the second portion 20 from its central fixation point or root to the tip is designed such that a desired curvature can be obtained under fan operating conditions. Preferably, the blade's longitudinal edge profile is slightly tapered from centre to tip, to ensure an essentially uniform curvature when rotating, as otherwise the blade may simply bend backwards at a single line, usually at the end of the root or central fixature. Accordingly, when operating the fan 10, the top edge of each blade 14 starts trailing the root during operation, thereby forming a backward-curved blade. The fan thus forms a nominally polygonal shape creating a radially outwardly directed air flow from the radial impeller. According to a first preferred form of the present invention, the fan 10 is adapted for rotation about its axis within the incubator, and each blade 14 extends outwardly from a root located in the vicinity of the axis to a tip located remote from the axis; and the blade width, measured in a direction parallel to axis, decreases in moving outwardly from the root to the tip location. Because the blades 14 of the fan 10 are made of a flexible material, the blades are curved against the direction of rotation of the fan during its operation. Thereby. the curvature of each blade mimics that of an air foil cross-section to provide good operating efficiency. In fact, to the fan 10 has backward-curved blades 14 in either rotation direction, thus providing a highly energy efficient air flow in opposite directions of rotation.

Also preferably, the fan 10 has at least four, more preferably five to eight, still more preferably five or six, blades 14. The radial length, as measured from the hub 12, of each blade 14 and its first and second portions 18, 20 is not considered critical and will generally depend on the longitudinal width of the blade 14, on the dimensions of the incubator and on the number and arrangement of eggs within the incubator. Likewise, the longitudinal width of each blade 14 and its first and second portions 18, 20 is not considered critical and will generally depend on the of the radial length of the blade 14, on the dimensions of the incubator and on the number and arrangement of eggs within the incubator

Also preferably, the first portion 18 of each blade 14 includes a pair of parallel, laterally-aligned, radially-extending arms 21 with a laterally-extending opening 22 between them. One end of each arm 21 is attached to the hub 12 and the other end is attached to one longitudinal end of a longitudinally-extending, rigid attachment member 23. The attachment member 23 is attached to a longitudinally-extending lower end of the second portion 20 of the blade 14. The opening 22 between the arms 21 promotes the smooth rotation of the first portion with the hub 12, without significant lateral deformation of the first portion by air pressure generated by rotation of the blade.

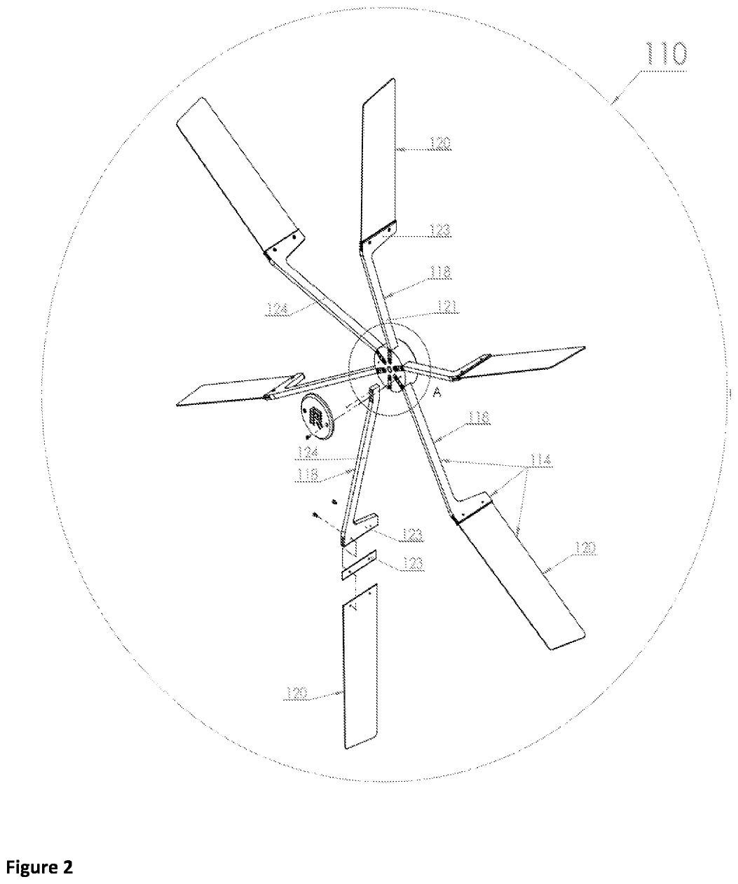

Also in accordance with this invention, a second embodiment of a radial fan 110 is provided as shown in FIG. 2. The radial fan 110 of FIG. 2 has essentially the same features as the fan 10 of FIG. 1, and corresponding elements of the fan 110 of FIG. 2 have reference numbers greater by 100 than the corresponding elements of the fan 10 of FIG. 1.

The fan 110 of FIG. 2 has, at its radial centre, a longitudinally-elongated, generally tubular hub 112. A plurality of, radially-extending, preferably self-supporting, fan blades 114, are arranged circumferentially around a first longitudinal end portion 116 of the hub 112. Each blade extends radially away from the hub 112. In accordance with this invention, the hub 112 can be rotated clockwise and counter-clockwise around its longitudinal axis to rotate the blades 114 clockwise and counter-clockwise around the longitudinal axis of the hub. For this purpose, a reversible torque source 117 (not shown) can be attached to an opposite, second longitudinal end portion of the hub 112 to rotate the hub in opposite directions about its longitudinal axis.

A first portion 118 of each blade 114 of the fan 110 of FIG. 2 is adjacent and attached to the circumference of the hub 112. A second portion 120 of each blade 114 is attached to the first portion 118 of the blade. The second portion 120 of each blade is deformable, preferably bendable, laterally, so that the second portion 120 is deformed laterally in a counter-clockwise direction by air pressure when being rotated by the hub 112 in a clockwise direction about the longitudinal axis of the hub and is deformed laterally in a clockwise direction by air pressure when being rotated by the hub in a counter-clockwise direction about the longitudinal axis of the hub. Preferably, the first portion 118 of each blade 114 is significantly more rigid laterally than the second portion 120 of the blade. More preferably, the first portion of each blade is substantially rigid laterally, and the second portions of each blade is flexible laterally. In this regard, the fan 110 is preferably a straight backward curved multi-bladed radial flow device rotatable about its axis, whereby the blades preferably deform under rotation to form backward curved blades relative to the rotation direction and provide a more planar air flow with less swirl.

Preferably, the second portion 120 of each blade 114 is made of a deformable polymeric plastic material, such as low-density polyethylene, plasticised polyvinyl chloride or polypropylene. The first portion 118 of each blade 114 is preferably made of a metal such as aluminium or a relatively rigid plastic such as a non-plasticised polyvinyl chloride, polypropylene or a high-density polyethylene. Preferably the second and further portions, or the entire blade if integral may be prepared from an engineering plastic material, such as e.g. polypropylene and/or nylon, preferably reinforced with glass-fibers. Preferably, the material is chosen according to the desired deformation, and to conditions needed to clean and/or sterilize the blade.

Also preferably, the fan 110 has at least four, more preferably five to eight, still more preferably five or six, blades 114. The radial length, as measured from the hub 112, of each blade 114 and its first and second portions 118, 120 is not considered critical and will generally depend on the longitudinal width of the blade 114, on the dimensions of the incubator and on the number and arrangement of eggs within the incubator. Likewise, the longitudinal width of each blade 114 and its first and second portions 118, 120 is not considered critical and will generally depend on the of the radial length of the blade 114, on the dimensions of the incubator and on the number and arrangement of eggs within the incubator

Also preferably, the first portion 118 of each blade 114 includes a radially-extending, asymmetric L-shaped arm 121. The arm 121 is formed by a rigid, radially-extending rod 124, one end of which is attached to the hub 112 and the other end of which is attached to one longitudinal end of a longitudinally-extending, two-part, rigid attachment member 123. The attachment member 123 is attached to a longitudinally-extending lower end of the second portion 120 of the blade 114. The L-shape of the arm 121 promotes the smooth rotation of the first portion 118 with the hub 112, without significant lateral deformation of the first portion by air pressure generated by rotation of the blade 114.

Also in accordance with this invention, an incubator (not shown) is provided for poultry eggs and newly hatched poultry. The incubator contains a radial fan 10 or 110 of FIG. 1 or 2. The radial fan has a longitudinally-elongated, generally tubular hub 12 or 112 and a plurality of longitudinally and radially-extending, self-supporting fan blades 14 or 114, arranged circumferentially around a longitudinally-extending axis of the hub. The axis of the hub 12 or 112 extends horizontally into the interior of the incubator, and the hub is rotatable around the axis of the hub to rotate the blades clockwise and counter-clockwise around the axis of the hub. A reversible torque source 17 or 117 (not shown) is preferably attached to the hub 12 or 112 to rotate the hub and the blades 14 or 114 in opposite directions about the longitudinal axis of the hub and thereby laterally deform the blades in opposite directions.

It has been found that the preferred radial fan 10 or 110 can provide flows of air with less clockwise and/or counter-clockwise spins around the eggs in the incubator. This can help to make embryo temperatures more uniform throughout the egg mass in the incubator, thereby reducing mortality in the incubator. It has also been found that the preferred radial fan 10 or 110 in the incubator can provide air flows with alternating clockwise and counter-clockwise spins around the eggs and newly hatched poultry in the incubator which create a mild turbulence in the environment in the incubator which is beneficial for the eggs and newly hatched poultry. Yet more preferably it has been found that if the blades of the radial fan deform to a crest-like shape during operation, the lateral component of the flow is reduced, and the thus generated air flow is more planar and with less swirl over the entire space, thereby reducing local temperature differences.

According to a preferred embodiment of the incubator of the invention, the radial fan 10 or 110 is positioned on a wall, preferably an upstanding wall, such as for instance a back wall (remote from the door(s)), or a central wall structure of the incubator acting as a central fan tower in the incubator. Preferably, the fan is mounted in close proximity to the wall. Preferably, the reversible torque source 17 or 117, driving the fan 10 or 110, is placed outside the incubator, thereby reducing the requirement to clean electrical equipment. Preferably, the fan is also positioned in the incubator in close proximity to a heat exchange element, which can be incorporated into a wall, such as the back wall of the incubator, or into an upstanding fan tower at the middle of the incubator.

According to another preferred embodiment of the incubator of the invention, the radial fan 10 or 110 is positioned essentially on a floor, and in the middle, of the incubator, containing stacks of hatching crates which are positioned on the floor at each side of the fan. In this embodiment, a heat exchange element can be composed of semipermeable baffles or walls placed inside the incubator and preferably in close proximity to the fan.

The radial fan in the incubator preferably has an outer diameter in the range of from 50 to 90% of the incubator chamber height. More preferably, it may have an outer diameter in the range of from 60 to 80% of the incubator chamber height. The inner height herein refers to the free height available inside the chamber.

Also in accordance with this invention, the use of a radial fan is provided to provide an essentially uniform air flow in an incubator that is more planar with less swirl than heretofore provided by conventional fans. Preferably, the radial fan, used, is the radial fan 10 or 110, described above and shown in FIG. 1 or 2, with self-supporting fan blades 14 or 114 and with a hub 12 or 112 that is rotatable clockwise and counter-clockwise around the axis of the hub to rotate the blades clockwise and counter-clockwise around the axis of the hub. The hub 12 or 112 of the radial fan 10 or 110 of this use is attached to a reversible torque source 17 or 117.

Also in accordance with this invention, a process for the control of an environmental factor in an incubator. The process comprises operating a radial fan in the incubator, wherein the rotation direction of the fan is varied at predetermined time intervals. Preferably, the environmental factor is selected from air temperature, air humidity and/or air composition. Preferably, the radial fan of this process is the radial fan 10 or 110, described above and shown in FIG. 1 or 2, with self-supporting fan blades 14 or 114 and with a hub 12 or 112 that is rotatable clockwise and counter-clockwise around the axis of the hub to rotate the blades clockwise and counter-clockwise around the axis of the hub. The hub 12 or 112 of the radial fan 10 or 110 of this process is attached to a reversible torque source 17 or 117.

1. A radial fan for providing a uniform airflow in an incubator, comprising a longitudinally-elongated, generally tubular hub and a plurality of self-supporting, longitudinally- and radially-extending, planar fan blades, arranged circumferentially around a longitudinally-extending axis of the hub; the hub being rotatable clockwise and counter-clockwise around the axis of the hub to rotate the blades clockwise and counter-clockwise around the axis of the hub; wherein each blade is configured to deform under rotation and/or air pressure such that the distal end of each blade is biased aft of the blade radial axis in the rotation direction.

2. The radial fan according to claim 1, wherein each blade comprises at least a first portion of each blade being radially adjacent to, and attached to, the hub; and at least a second portion of each blade being attached to the first portion of the blade and extending radially away from the first portion; the second portion and further portions of each blade being deformable, preferably bendable, laterally, whereby the second and further portion are: i) deformed, preferably bent and curved, laterally in a counter-clockwise direction by air pressure when being rotated in a clockwise direction by the hub, and ii) deformed, preferably bent and curved, laterally in a clockwise direction by air pressure when being rotated in a counter-clockwise direction by the hub.

3. The radial fan according to claim 1 wherein the first portion of each blade is significantly more rigid laterally than the second or further portions of the blade.

4. The radial fan according to claim 1, wherein the first portion of each blade is substantially more rigid laterally, and the second and further portions of each blade are increasingly laterally flexible.

5. The radial fan according to claim 1, wherein the second and further portions are integral and have a diminishing thickness profile towards the distal end of the blade.

6. The radial fan according to claim 5 wherein the first portion of each blade is made from a light weight material, preferably sufficiently strong to maintain the blades attached to the hub during operation, preferably the material comprising a metal or metal alloy such as particularly aluminium or alloys thereof, and the second and further portions of each blade are made from a non-rigid polymeric material composition.

7. The radial fan according to claim 6, wherein the first portion of each blade is not substantially deformed even when being rotated by the hub.

8. The radial fan according to claim 6, wherein the polymeric material composition comprises polypropylene, or an engineering polymer that may be sterilized without deformation.

9. The radial fan according to claim 1, wherein the first and second or further portions of each blade are made as a single, self-supporting piece from a plastic composition, wherein the second portion is significantly more deformable laterally than the first portion.

10. The radial fan according to claim 1, which comprises at least four, preferably five to eight, more preferably five or six, blades.

11. The radial fan according to claim 1, wherein the first portion of each blade includes a pair of parallel, laterally-aligned, radially-extending arms with a laterally-extending opening between them.

12. The radial fan according to claim 1, wherein the first portion of each blade includes a radially-extending, asymmetric L-shaped arm.

13. An incubator for poultry eggs and newly hatched poultry comprising a radial fan with a longitudinally-elongated, generally tubular hub and a plurality of longitudinally- and radially-extending, self-supporting, fan blades, arranged circumferentially around a longitudinally-extending axis of the hub; wherein each blade is configured to deform under rotation and/or air pressure such that the distal end of each blade is biased aft of the blade radial axis in the rotation direction.

14. An incubator for poultry eggs and newly hatched poultry comprising a radial fan according to claim 1.

15. The incubator according to claim 14, wherein the fan is mounted on, and in close proximity to, an upstanding wall, preferably a back wall of, or a fan tower located at an essentially central position inside of the incubator.

16. The incubator of claim 15 wherein the fan is mounted in close proximity to a heat exchange element in the incubator.

17. The incubator of claim 16 wherein the heat exchange element is in the upstanding wall of the incubator or in an upstanding wall at the middle of the incubator.

18. The incubator of claim 14, wherein the radial fan is mounted on a floor at the middle, preferably at a central line separating the incubator interior ground surface into two rectangular portions, of the incubator.

19. The incubator of claim 14 wherein the fan has an outer diameter in the range of from 50 to 90% of the incubator height.

20. (canceled)

21. A process for the control of an environmental factor in an incubator,
the process comprising operating a radial fan of claim 1 in an incubator, wherein the rotational direction of the fan is varied at predetermined time intervals.

22. The process according to claim 21, wherein the environmental factor is selected from air temperature, air humidity and/or air composition.
